(19) United States
(12) Patent Application Publication
(10) Pub. No.: US 2022/0260099 A1
(43) Pub. Date: Aug. 18, 2022

(54) RETAINER WHICH CAN BE FASTENED TO A STAND

(71) Applicant: Franz Neuhofer, Zell am Moos (AT)

(72) Inventor: Franz Neuhofer, Zell am Moos (AT)

(21) Appl. No.: 17/611,785

(22) PCT Filed: May 12, 2020
(86) PCT No.: PCT/AT2020/060196

§ 371 Date: Nov. 16, 2021

(30) Foreign Application Priority Data
May 23, 2019 (AT) A50475/2019

(51) Int. Cl. F16B 2/14; F16M 11/04

(52) U.S. Cl. CPC F16B 2/14; F16M 11/041

(57) ABSTRACT

The invention relates to a retainer which can be fastened to a stand (1), having two jaws (2) which enclose the stand (1) in a clip-like manner and are guided displaceably relative to one another perpendicularly to their butt face (3) and, on the ends forming the butt faces (3), have connecting shoulders (4) which are opposite one another in pairs. In order to create advantageous design conditions, it is proposed that the connecting shoulders (4) form, on the side thereof facing away from the butt face (3), wedge faces (5) extending inclined relative to each other and each interact with a clamping shoe (8) surrounding the wedge-shaped connecting shoulders (4) in a wedge-shaped socket (9), and that the two jaws (2) each comprise, on the inside thereof, a guide ridge (6) which protrudes beyond the butt face (3) towards the other jaw (2) and engages in a guide groove (7) of the other jaw (2).

### FIELD OF THE INVENTION

The invention relates to a retainer which can be fastened to a stand, having two jaws which enclose the stand in a clip-like manner and are guided displaceably relative to one another perpendicularly with respect to their butt face and, on the ends forming the butt faces, have connecting shoulders which are opposite one another in pairs.

### DESCRIPTION OF THE PRIOR ART

In order to be able to attach various accessories to stands of wooden shelves in particular, it is known to clamp retainers to these stands in a clip-like manner, which has the advantage that, on the one hand, the stands do not have to be drilled into and, on the other hand, a continuous displacement of the retainers along the stands is made possible. For this purpose, known retainers have two U-shaped jaws which enclose the stands, which are usually rectangular in cross-section, from opposite sides and which, at their butt faces, form outwardly angled connecting shoulders in the form of flanges, via which the two jaws of a retainer are connected with the aid of screws, so that the two jaws rest under pretension against the surfaces of the stands which are parallel to the flanges. The disadvantage is that the flanges protruding from the jaws require space in a disruptive manner and that the jaws of the retainer cannot be clamped to the stands without tools.

In order to be able to clamp objects to a stand profile, it is also known (GB 2 078 098 A) to provide two clamping jaws which grip around two mutually facing or mutually averted longitudinal edge webs of the stand profile and form mutually inclined extending wedge faces on mutually facing or mutually averted folding webs, which cooperate with a clamping shoe which can be fitted onto the folding webs, so that the clamping jaws are either pressed apart or drawn towards one another, depending on the progression of the inclination of the wedge faces, with the result that the clamping jaws are held clamped between the longitudinal edge webs. Apart from the fact that these known clamping jaws presuppose stand profiles with two longitudinal edge webs facing each other or facing away from each other, the difficulty arises that the mutual position of the two clamping jaws along the longitudinal edge webs is not predetermined by design, which leads to the fact that the clamping shoe and thus an object connected to the clamping shoe is displaced transversely to these longitudinal edge webs in dependence on a mutual displacement of the clamping jaws in the direction of the longitudinal edge webs.

In other clamping jaws gripping around a stand in a clip-like manner (DE 43 03 832 A1, US 2013/0206938 A1), these clamping jaws are themselves displaceably guided relative to one another in the longitudinal direction of the stand via wedge faces, which precludes mutual alignment of the two clamping jaws in the longitudinal direction of the stand.

### SUMMARY OF THE INVENTION

The invention is thus based on the object of designing a retainer for fastening accessories to a stand in such a way that simple, tool-free assembly is ensured, with a comparatively small space requirement, without having to fear mutual displacement of the clamping jaws.

Starting from a retainer of the type described at the outset, the invention solves the problem posed in that the connecting shoulders form, on the side thereof facing away from the butt face, wedge faces extending inclined relative to each other and each interact with a clamping shoe surrounding the wedge-shaped connecting shoulders in a wedge-shaped socket, and in that the two jaws each comprise, on the inside thereof, a guide ridge which protrudes beyond the butt face towards the other jaw and engaging in a guide groove of the other jaw.

Due to these design requirements, after the two jaws have been brought together around the stand, the clamping shoes only need to be pushed onto the wedge-shaped connecting shoulders of the two jaws in order to pull the two jaws against each other via the wedge-shaped socket of the clamping shoes and to fix them to the stand in a clamping manner. The clamping shoes can have a small overall depth, because it is only necessary to accommodate the wedge-shaped connecting shoulders of the jaws in the wedge-shaped socket of the clamping shoes.

In order to fix the two jaws in their position enclosing the stand against each other in the longitudinal direction of the stand, the two jaws are guided so as to be displaceable towards each other transversely to the longitudinal direction of the stand, namely with the aid of guide ridges projecting beyond the butt face against the other jaw and engaging in a guide groove of the other jaw, so that the two jaws are automatically aligned towards each other when brought together and are also held in this alignment position when the clamping shoes are pushed on.

Particularly simple handling conditions are obtained when the wedge-shaped sockets of the clamping shoes form an undercut guide groove in which the wedge-shaped connecting shoulders engage positively, because in this case loosening of the clamping shoes transversely to the stand is prevented by the form fit between the connecting shoulders of the jaws and the undercut guide groove of the clamping shoes.

If the clamping shoes have a resilient latching tongue interacting with a latching toothing of the wedge-shaped connecting shoulders, the respective position of the clamping shoes relative to the wedge-shaped connecting shoulders of the jaws can be secured by means of the latching toothing. The resilient latching tongue engaging in the latching toothing prevents the clamping shoes from being pulled off the wedge-shaped connecting shoulders of the jaws in the direction opposite to the direction in which the clamping shoes are fitted.

Since the surface of the usually wooden stands, which is often sensitive to mechanical stresses, should not be exposed to any risk of injury by the retainer, the two jaws can be provided with a friction lining on their inner side facing the stand. The respective friction linings significantly improve the frictional connection between the stand and the jaws and at the same time protect the surface of the stand.

Accessories may be supported on the jaws or attached thereto. For some accessories, however, particularly simple fastening conditions result if at least one of the two clamping shoes is part of a structural element to be fastened to the stand. Load transfer via at least one clamping shoe also has the advantage that the weight load of the clamping shoe can be used to secure or reinforce the clamping forces between the jaws and the stand, if this weight load acts on the wedge-shaped connecting shoulders of the stands in the push-on direction of the clamping shoe.

### BRIEF DESCRIPTION OF THE INVENTION

In the drawing, the subject matter of the invention is shown by way of example, wherein:

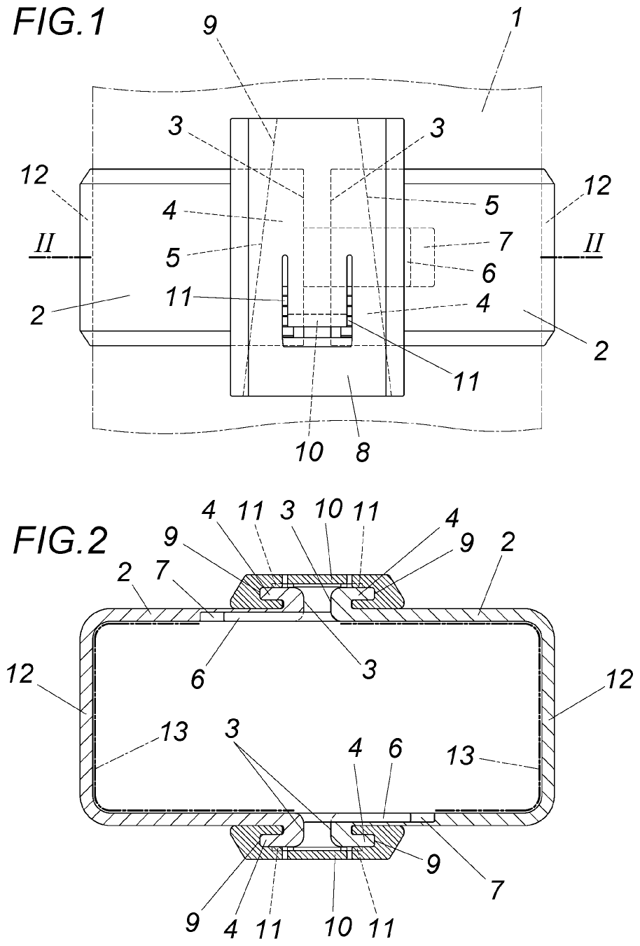

FIG. 1 shows a side view of a retainer according to the invention,

FIG. 2 shows this retainer in section along line II-II of FIG. 1,

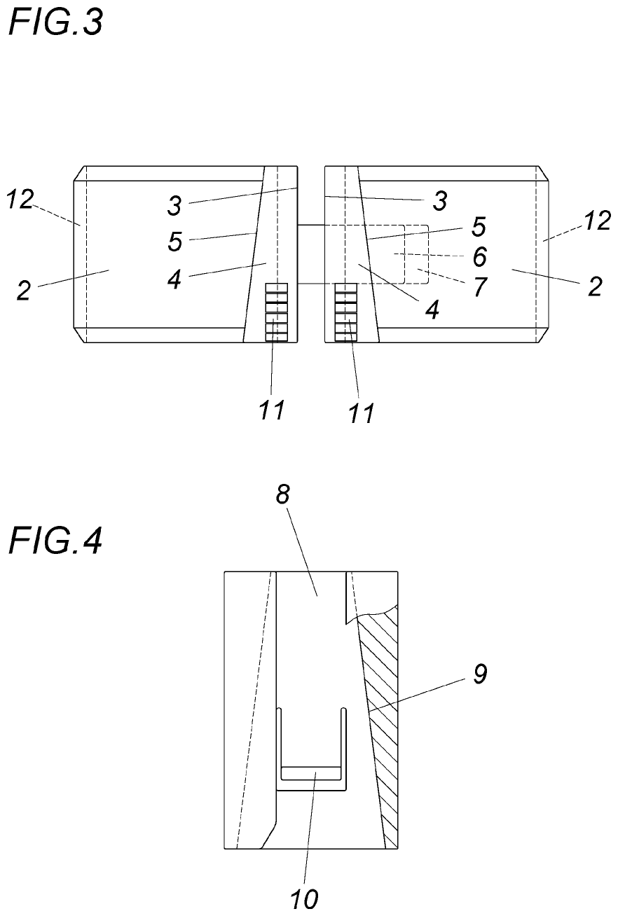

FIG. 3 shows the two jaws of the retainer pushed together in a side view without clamping shoes and

FIG. 4 shows a clamping shoe in a partially elevated view of the inside.

### DETAILED DESCRIPTION OF THE PREFERRED EMBODIMENTS

The retainer according to the invention comprises two U-shaped jaws 2 enclosing a parallelepipedal, preferably wooden stand 1, which jaws are provided with connecting shoulders 4 at their mutually opposite ends forming butt faces 3. These connecting shoulders 4, which lie opposite one another in pairs, form wedge faces 5 on their side facing away from the butt faces 3, which wedge faces 5 extend in an inclined manner relative to one another, as can be seen in particular from FIG. 3.

For mutual guidance of the jaws 2, which are displaceable perpendicularly to the butt faces 3, each of the two jaws 2 is provided on its inner side with a guide ridge 6, which projects beyond the butt face 3 towards the other jaw 2 and engages in a guide groove 7, which is open towards the stand 1, of the respective other jaw 2.

Clamping shoes 8, which are provided with a wedge-shaped socket 9, serve to connect the two jaws 2. This socket 9 is designed in the form of an undercut guide groove which accommodates the wedge-shaped connecting shoulders 4 of the jaws 2 in a form-fitting manner, as can be seen in particular from FIG. 2.

In order that the respective clamping position of the clamping shoes 8 on the wedge-shaped connecting shoulders 4 can be secured in a simple manner, the clamping shoes 8 form a resilient latching tongue 10 which interacts with latching teeth 11 of the connecting shoulders 4.

To clamp the retainer to a stand 1, the two jaws 2 are joined together from opposite sides around the stand 1 so that the guide ridges 6 engage in the guide grooves 7. To clamp the jaws 2 to the stand 1, the clamping shoes 8 are then fitted onto the wedge-shaped connecting shoulders 4 so that their wedge faces 5 come into operative connection with the wedge-shaped socket 9 of the clamping shoes 8 and the jaws 2 are pulled towards one another until the jaw webs 12, which connect the limbs of the U-shaped jaws 2, rest against the mutually opposite sides of the stand 1 in a clamping manner under an appropriate pretension. The clamping position of the clamping shoes 8 is secured by the latching of the clamping shoes 8 relative to the connecting shoulders 4 by means of the latching tongues 10 engaging in the latching teeth 11, and can only be released when the latching tongue 12 is disengaged from the latching teeth 11.

In order to improve the frictional connection between the jaws 2 and the stand 1, at least the jaw webs 12 may be provided with a friction lining 13 on their inner side.

1. A retainer that is configured to be fastened to a stand, having said retainer comprising:
two jaws that enclose the stand in a clip-like manner and are each guided for displacement relative to one another perpendicularly with respect to a butt face thereof and, on ends of the laws forming the butt faces, the laws have connecting shoulders opposite one another in pairs,
wherein the connecting shoulders form, on sides thereof facing away from the respective butt face, wedge faces extending inclined relative to each other and each of said wedge faces interacting with a clamping shoe surrounding a wedge shape structure of the connecting shoulders in a wedge-shaped socket, and
wherein the two jaws each comprise, on an inside thereof, a guide ridge that protrudes beyond the butt face towards the other of said jaws and engages in a guide groove of the other of said jaws.

2. The retainer according to claim 1, wherein the wedge-shaped socket of the clamping shoe forms an undercut guide groove in which the wedge shape structure of the connecting shoulders engage in a form-fitting manner.

3. The retainer according to claim 1, wherein the clamping shoe comprises a resilient latching tongue interacting with a latching toothing of the connecting shoulders.

4. The retainer according to claim 1, wherein the two jaws are provided with a friction lining on inner sides thereof facing the stand.

5. The retainer according to claim 1, wherein the clamping shoe is part of a structural element configured to be fixed to the stand.

6. The retainer according to claim 1, wherein the jaws have additional connecting shoulders with a wedge shape structure engaging a second clamping shoe with a wedge shaped socket.

7. The retainer according to claim 6, wherein the wedge-shaped sockets of the clamping shoes each form a respective undercut guide groove in which the wedge shape structures of the connecting shoulders engage in a form-fitting manner.

8. The retainer according to claim 6, wherein the clamping shoe comprises a resilient latching tongue interacting with a latching toothing of the connecting shoulders.

9. The retainer according to claim 6, wherein the two jaws are provided with a friction lining on inner sides thereof facing the stand.

10. The retainer according to claim 6, wherein at least one of the two clamping shoes is part of a structural element configured to be fixed to the stand.

11. The retainer according to claim 2, wherein the clamping shoe comprises a resilient latching tongue interacting with a latching toothing of the connecting shoulders.
